(19) United States
(12) Patent Application Publication
(10) Pub. No.: US 2016/0233580 A1
(43) Pub. Date: Aug. 11, 2016

(54) METHOD AND APPARATUS TO CONTROL THE GAIN OF A MILLIMETER WAVE PHASED ARRAY SYSTEM

(71) Applicant: QUALCOMM Incorporated, San Diego, CA (US)

(72) Inventors: Vladimir Aparin, San Diego, CA (US); Karim Arabi, San Diego, CA (US)

(21) Appl. No.: 14/615,969

(22) Filed: Feb. 6, 2015

(51) Int. Cl. H01Q 3/28; H01Q 3/26

(52) U.S. Cl. CPC H01Q 3/28; H01Q 3/267

(57) ABSTRACT

The systems and method described herein provide efficient wireless communication in a millimeter wave (MMW) phased array system. The system may comprise a plurality of antenna elements, each of the plurality of antenna elements coupled to a transceiver and transceiver having at least one power amplifier. The system may further comprise a gain controller configured to enable or disable the transceivers in response to a power detector output indicating that one or more antenna elements are blocked. Disabling certain transceivers of blocked antenna elements enables the power amplifiers associated with the unblocked antenna elements to continue to operate at maximum efficiency.

### TECHNOLOGICAL FIELD

This disclosure is generally related to wireless communications. More particularly, the disclosure is related to millimeter wave phased array communication systems.

### BACKGROUND

Millimeter wave (MMW) transmissions travel by line-of-sight, and may be blocked by building walls or attenuated by foliage. The high free space loss and atmospheric absorption may sometimes limit propagation to a few kilometers. Thus MMW are useful for densely packed communications networks such as personal area networks that improve spectrum utilization through frequency reuse.

Due to the relatively high attenuation of MMW transmissions, multiple-antenna arrays may be used to increase the accuracy and gain of received transmissions. Some of the antennas arrays may be multiple-in, multiple-out (MIMO) antenna arrays or phased array systems.

### SUMMARY

One aspect of the disclosure provides a phased array system, comprising a first antenna element and a second antenna element. A first transceiver can have a first power amplifier and be operably coupled to the first antenna element. A second transceiver can have a second power amplifier and be operably coupled to the second antenna element. A first power detector can be coupled to the first antenna element and provide a first detector output. A second power detector can be coupled to the second antenna element and provide a second detector output. A gain controller can be operably coupled to the first transceiver, the first power detector, the second transceiver and the second power detector. The gain controller can disable one or more of the first transceiver and the second transceiver based on the first detector output and the second detector output.

Another aspect of the disclosure provides a method for wireless communication in a phased array system. The phased array system can have at least a first antenna element operably coupled to a first transceiver having a first power amplifier and a second antenna element operably coupled to a second transceiver having a second power amplifier. The method may comprise enabling the first transceiver and the second transceiver. The method may further comprise detecting a detector output from at least one of the first power detector and the second power detector. The method may further comprise disabling one or more of the first transceiver and the second transceiver based on the detector output while maintaining operation of the antenna array in a predetermined range of maximum efficiency.

Another aspect of the disclosure provides an apparatus for wireless communication in a phased array system. The phased array system can have a first antenna element and a second antenna element operably coupled to a respective first transceiver and a second transceiver of a plurality of transceivers. The apparatus may comprise a gain controlling means for enabling each of the first transceiver and the second transceiver. The gain controlling means can further disable one or more of the first transceiver and the second transceiver based on a detector output while maintaining maximum efficiency of the enabled transceivers. The apparatus may further comprise a first detecting means for providing a first detector output to the gain controlling means. The first detecting means can be operably coupled to the first antenna. The apparatus may further comprise a second detecting means for providing a second detector output to the gain controlling means. The second detecting means can be operably coupled to the second antenna.

Another aspect of the disclosure provides a phased array system comprising a plurality of antenna elements. Each antenna element of the plurality of antenna elements can be coupled to a respective transceiver of a plurality of transceivers. Each transceiver can have at least one power amplifier with an adjustable gain. A power detector can be coupled to each antenna of the plurality of antenna elements and configured to provide a detector output. The detector output can be configured to indicate at least an output power level and a reflected energy level at a respective antenna element of the plurality of antenna elements. A gain controller can be operably coupled to each of transceiver of the plurality of transceivers and to each power detector. The gain controller can receive the detector output. The gain controller can further adjust the adjustable gain of one or more selected power amplifiers to achieve a selected transmit power level for the phased array system based on the detector output. The gain controller can further enable or disable one or more of the transceivers of the plurality of transceivers based on the detector output.

Other features and advantages of the present invention should be apparent from the following description which illustrates, by way of example, aspects of the invention.

### DESCRIPTION OF THE DRAWINGS

The details of the present disclosure, both as to its structure and operation, may be gleaned in part by study of the accompanying drawings, in which like reference numerals refer to like parts, and in which:

FIG. 1 is a plot diagram illustrating an example of total transmission efficiency versus effective isotropically radiated power (EIRP) of an exemplary phased array system;

FIG. 2 is a functional block diagram of an exemplary embodiment of a phased array system according to the present disclosure;

FIG. 3 is a plot diagram illustrating an example of total transmission efficiency of the exemplary phased array system of FIG. 2;

FIG. 4A is a flowchart depicting an exemplary method for selectively disabling transceivers to maintain optimum efficiency in a phased array system according to the present disclosure; and

FIG. 4B is a flowchart depicting another embodiment for selectively disabling transceivers to maintain optimum efficiency in a phased array system.

### DETAILED DESCRIPTION

The detailed description set forth below, in connection with the accompanying drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in simplified form for brevity of description.

Millimeter wave (mmW or MMW) transmissions are generally deemed to fall within the 30 to 300 gigahertz frequencies of the electromagnetic spectrum. This range may also be referred to as the Extremely High Frequency (EHF) range. EHF is the International Telecommunications Union (ITU) designation for the band of radio frequencies, above which electromagnetic radiation is considered to be far infrared light, also referred to as terahertz radiation. Radio waves within the MMW band have wavelengths from approximately one to ten millimeters, giving it the name millimeter band or millimeter wave.

Due to the transmission frequency and wavelength of MMW radiation, MMW systems may be susceptible to atmospheric absorption and attenuation. MMW transmissions may be impeded or attenuated by structures (e.g., walls and buildings) or other natural phenomena such as foliage or precipitation. As such, some MMW systems may use antenna arrays such as the phased arrays to increase the gain of a wireless system and compensate for the extra propagation path losses. Thus, MMW systems may be configured to adjust the gains (G) of both receiver and transmitter to boost the strength of an otherwise attenuated signal.

Phased array antennas may comprise a plurality of antenna elements that use the phase and magnitude of transmitted energy to “steer” transmitted radiation, creating multiple beams or transmission “lobes.” Transmitted energy may be steered or directed by exploiting constructive or destructive interference resulting from variations in phase and magnitude in the electromagnetic energy across the plane of transmitting phased array elements.

MMW systems may be configured with programmable gains implemented in multiple internal components such as low-noise amplifiers (LNA), power amplifiers (PA), mixers, and intermediate frequency (IF)/baseband (BB) amplifiers. The total radiated energy from a phased array antenna may then be controlled by adjusting the gain of the various PAs, LNAs, or similar components. However, reduction of transmitter power by adjusting the gain of the amplifying components can, at some level, reduce the components' efficiency resulting in suboptimum performance and power loss. For example, as the gain of a PA of one or more antenna elements is reduced to decrease total transmitted power, the PA bias shifts towards class-A amplifier operation. This may also shift the load impedance away from the optimum, matched impedance.

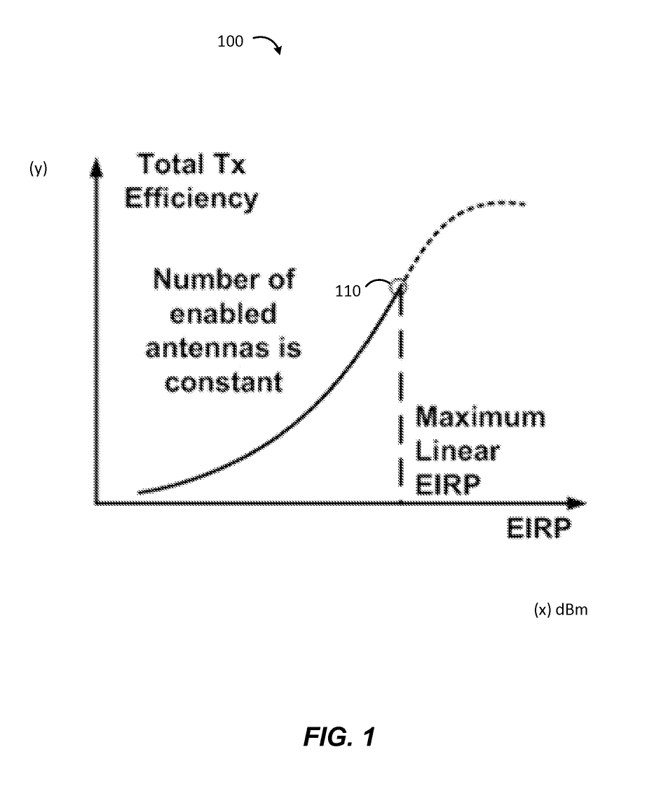

FIG. 1 is a plot diagram illustrating an example of total transmission efficiency versus effective isotropically radiated power (EIRP) of an exemplary phased array system, according to the disclosure. The vertical (y) axis is total transmission efficiency and the horizontal (x) axis is EIRP. EIRP may be referred in terms of decibels, specifically dBm, or the power ratio in decibels of the measured power referenced to one milliwatt (mW). EIRP may alternatively be referred to in terms of dBW, which is referenced to one watt (W).

As described herein, EIRP may generally refer to the amount of power that a theoretical isotropic antenna (which evenly distributes power in all directions) would emit to produce the peak power density observed in the direction of maximum antenna gain. In certain embodiments, EIRP may take into account losses occurring within certain transmission components (e.g., the LNAs, PAs, etc.) and connectors and includes the gain of an antenna element or entire antenna array. The EIRP is often stated in terms of decibels (dBm, dBW) in excess of a reference power emitted by an isotropic transmitter with equivalent signal strength. EIRP can be useful for comparisons between emitters of different types or those having different sizes or forms.

The exemplary phased array system described by the plot 100 assumes a fixed number of enabled phased array antenna elements. For example, the phased array that may produce the plot 100 of FIG. 1 may have eight antenna elements that are always enabled during a given transmission.

As shown, the plot 100 indicates that transmission efficiency of the system increases as the linearity of the resulting system EIRP decreases. A maximum linear EIRP 110 may be referred to as the maximum EIRP at which the system meets the linearity requirements. If a given system is required to transmit at a power level below the maximum linear EIRP 100, the gain of one or more of the PAs of the phased array elements may be reduced, reducing the overall power level of the entire phased array. In some embodiments this can result in a reduction in overall system efficiency because the system may consume more power than necessary for the given output power.

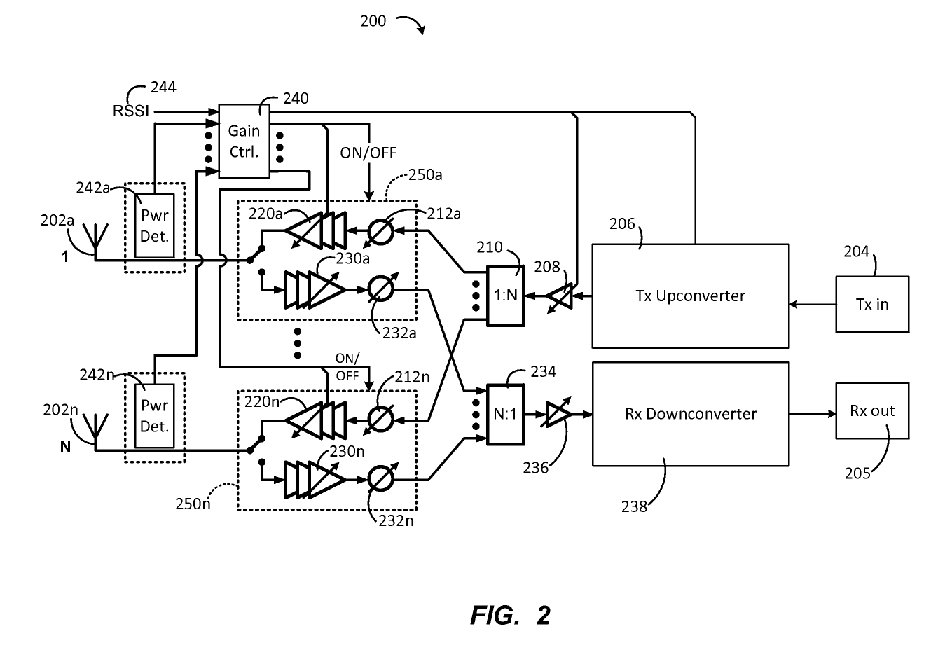

FIG. 2 is a functional block diagram of an embodiment of a phased array system. As shown, a phased array system 200 may include a plurality of antenna elements (elements) 202a-202n (collectively, elements 202). Each of the antenna elements 202 in general may each be considered an individual antenna.

The antenna elements 202 are labeled 202a, 202n indicating any number of antenna elements 202 may be present, for example, the antenna elements 1:N, as shown. As shown, a series of three dots similar to an ellipsis indicate the repeating portions of the elements of FIG. 2. This is shown in several places in FIG. 2. In some embodiments, each of the antenna elements 202 may operably connected, via various components as described below, to a transmitter input and a receiver output. In this embodiment each of the antenna elements 202 is configured to transmit and receive MMW transmissions, as disclosed herein.

The phased array system 200 may include a transmitter input (Tx in) 204. In some embodiments, the Tx in 204 may represent a transmitter input from a signal source from certain electronics, such as other elements of a radio (besides the phased array system) in a mobile electronic device. The transmitter input may be radio frequency (RF) transmissions or other similar inputs for transmission to a receiver.

The Tx in 204 is operably coupled to a transmitter (Tx) upconverter 206. The Tx upconverter 206 may include several subcomponents configured to convert an input to the frequency band in which the MMW phase array system 200 is operating.

The Tx up converter 206 may be operably connected to at least one transmitter variable gain amplifier (TxVGA) 208 configured to amplify the up converted signal as required. The TxVGA 208 may be operably coupled to a power splitter 210. The power splitter 210 may be configured to split the incoming signal from the TxVGA 208 into n portions for transmission to each of the antenna elements 202a-202n. In some embodiments, the power splitter 210 may split the signal into equivalent portions for transmission by each of the antenna elements 202. Each portion of the split signal may then be provided to a Tx phase shifter 212a-212n, as shown. The Tx phase shifters 212a-212n (collectively, Tx phase shifters 212) may be configured to shift the phase of the signal they receive as required to produce the desired transmission direction (e.g., for phased array beam forming) of the phased array system 200. The Tx phase shifters 212 may be operably coupled to a power amplifier, such as multistage power amplifier (PA) 220a-220n (collectively, PAs 220). The PAs 220 may include one or more stages of power amplifiers having a programmable gain, indicated by the arrow. The gain may be programmed by a controller, as described below. Each of the PAs 220 may be operably connected to the corresponding antenna elements 202a-202n. Accordingly, the PAs 220 may directly affect the power level of the signal transmitted from the antenna element 202.

In some embodiments, the connection between the PAs 220 and the elements 202 is a switched connection (as shown), allowing each of the antenna elements 202 to switch between transmitting a signal and receiving a signal.

In an embodiment, each of the antenna elements 202 may be operably connected to a multistage low noise amplifier (LNA) 230a-230n (collectively, LNAs 230) via the same switched connection. Due to relatively high attenuation of MMW transmissions, each of the LNA 230s may include one or more stages of low noise amplification, providing a usable signal to the rest of the array system 200. The LNAs 230 may be operably connected to a Rx phase shifter 232a-232n (collectively, Rx phase shifters 232) to incoming signals received at each of the antenna elements 202. Each of the Rx phase shifters 232 may further provide the phase shifted signal to a power combiner 234 which may further be operably connected to a RxVGA 236. The RxVGA 236 may adjust the gain of the combined received signal for further transmission to an Rx downconverter 238. The Rx downconverter 238 may be further operably coupled to a receiver output (Rx out) 205. The Rx out 205 may be analogous to an RF output that may be subject to further analysis or transform as required by a given mobile device or other applicable system.

In an embodiment, the phased array system 200 further includes a gain controller 240. The gain controller 240 may be operably coupled to each of the PAs 220 and configured to control the variable gain of the PAs 220. Such an adjustment may be beneficial in maintaining an optimum or matched impedance with the antenna elements 202. The gain controller 240 may also be configured to receive certain inputs from a power detectors 242a-242n (collectively power detectors 242). Each of the power detectors 242 may be operably coupled to a respective antenna element 202 in order to provide an estimation of transmit power levels or a received power levels across the array of antenna elements 202. The power detectors 242 may be configured to measure both incident RF energy and reflected RF energy at the antenna elements 202. For example, the reflected RF energy may be that energy that was transmitted at the antenna element 202a and reflected back to the antenna element 202a. The reflected energy may be indicative of antenna obstruction or blockage, such as blockage by a hand as in case of a mobile wireless device, (e.g., a UE).

The gain controller 240 may also be configured to receive a received signal strength indication (RSSI) 244. The RSSI 244 may be an overall or average signal strength indication received at the array system 200. The RSSI 244 input to the gain controller 240 may further provide a reference value for each of the power level measurements at each antenna element 202. Such a reference value may be further useful to the array system 200 for the determination of received signal or transmitted signal direction. In an embodiment, the RSSI 244 may be provided by the power detectors 242.

In some embodiments, the power detectors 242 may be capacitively coupled to each antenna element 202 and configured to measure the transmit power per channel (e.g., in each antenna element 202). Power detectors 242 may also be based on coupled transmission lines to further measure both incident and reflected waves (energy) for the given antenna element 202 to detect blockage of the antenna by a hand or other object.

Such an embodiment may control the gain of individual antenna elements 202 based on measurements of individual antenna element 202 transmit power and/or by monitoring the RSSI 244. The gain controller 240 may further vary the antenna transmit power by adjusting the power amplifier 220 gain individually on a per element basis (e.g., per antenna element 202), without individually disabling any antenna elements 202. Such an embodiment may further vary the gain of the LNAs 230 in order to adjust the power level of the received signal appropriately.

However, as noted above in FIG. 1, reducing transmitter power (e.g., the transmit power levels of the antenna elements 202) by adjusting or reducing the PA 220 gain reduces the overall efficiency of the array system 200 because the output power of the PA 220 decreases faster than its power consumption. In some embodiments, the output power of the PA 220 is proportional to the square of the bias current, while the power consumption is proportional to the bias current. This situation may arise, for example, when the phased array system 200 is implemented in user equipment (UE) such as phone or tablet. In such an embodiment, the user's hand may block a portion of the array system 200. Accordingly, the MMW phased array system 200 system may adjust for transmission blockage of part or all of the antenna elements 202 in the array system 200. However, transmission or attempted reception of signals through such blocked antennas may result in a significant waste of power.

The gain controller 240 may be further operably coupled to a plurality of transceiver blocks (transceivers) 250a-250n (collectively, transceivers 250). The transceivers 250, as described herein, may refer to the collective functions of at least each pair of the Tx phase shifters 212 and the PAs 220, and each pair of Rx phase shifters 232 and LNAs 230. The transceivers 250 are shown in dashed lines and may refer to at least the functions of the four elements described. For example, the transceiver 250arefers to the functions of the Tx phase shifter 212a, the PA 220a, the LNA 230a, and the Rx phase shifter 232a. In an embodiment, the transceivers 250 as disclosed herein may also refer to the waveform-producing/transmitting and receiving components, for example the PAs 220 and the LNAs 230. In another embodiment, the transceivers 250 may refer to a transmitter/receiver pair configured to transmit and receive energy from the antenna elements 202. In another embodiment, the transceivers 250 may refer to those components that draw power from the array system 200 during a transmit or receive operation from a particular antenna element 202 (e.g., the antenna element 202a); for example when the transceiver 250ais disabled, no power is transmitted from the antenna element 202a power to the transceiver is minimized.

In operation, the gain controller 240 may further be configured to remove or otherwise deactivate one or more respective transceivers 250 as required. Such operation may be similar to an ON-OFF power switch. This may serve to optimize the efficiency and transmission power level of the entire array system 200 by selectively removing power from selected transceivers 250.

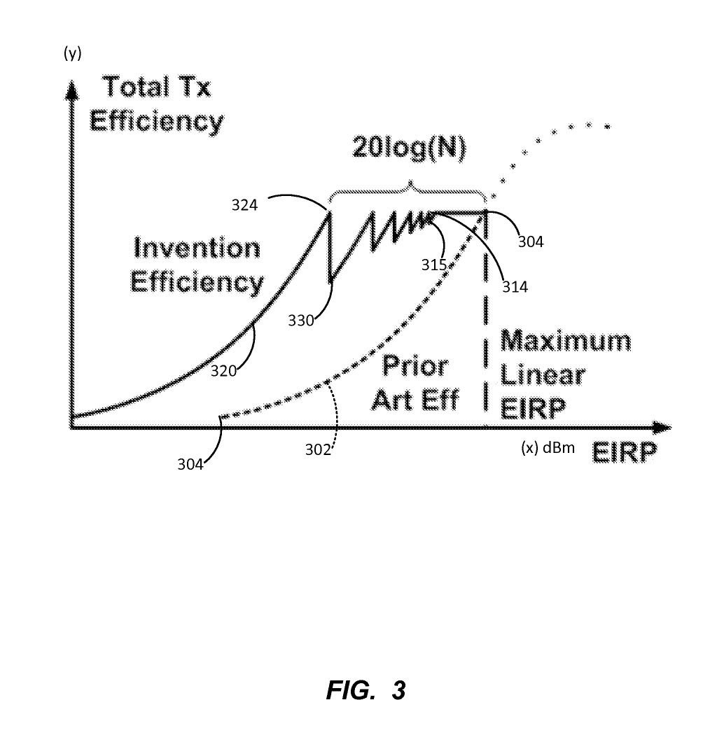

In an embodiment, and as described in connection with FIG. 3 below, in the presence of a blocked antenna element 202a, the gain controller 240 may receive power information regarding power levels from the power detectors 242. The information may indicate to the gain controller 240 that one or more of the antenna elements 202 is blocked or otherwise obstructed. In response, the gain controller may disable certain antenna elements 202, corresponding to certain blocked antennas (e.g., antenna elements 202) for example. Accordingly, the gain controller 240 removes power from the associated transceiver block 250a. As a result, no power may be delivered to the antenna element 202a. This may serve to reduce power consumption of the entire system (e.g., the array system 200) as noted below. In certain embodiments, the gain controller 240 may concurrently adjust (e.g., raise or lower) the gain of one or more of the other PAs 220 in response to the blocked antenna element(s) 202 in order to maintain maximum efficiency of the system 200.

FIG. 3 is a plot diagram illustrating an example of total transmission efficiency of the exemplary phased array system of FIG. 2. As shown, a plot diagram 300 depicts EIRP along the x-axis with total transmission (Tx) efficiency along the y-axis. Similar to the plot diagram 100 (FIG. 1), the units of EIRP may be referred to in terms of dBm/dBW.

The diagram 300 includes a dotted line 302 that is similar to the diagram 100, indicating the efficiency of a phased array system (e.g., the array system 200) incorporating adjustable gain at the PAs 220. The dotted line 302 increases from a minimum EIRP having a minimum efficiency at a point 304, to a maximum linear EIRP 306 (shown in a dashed line) at the right of the diagram 300.

The diagram 300 also depicts a line 320 that depicts the transmission efficiency of the array system 200 (FIG. 2) operated according to an embodiment of the present disclosure. The line 320 begins at a point 322 on the left of the curve and increases EIRP to maximum total efficiency at a point 324. The point 324 may have the same or similar efficiency as the point 304, but at a lower maximum EIRP.

According to such an embodiment, by disabling certain antenna elements 202, no signal is received and/or transmitted from those antenna elements 202. By disabling selected the receiver/transmitter pair (e.g., the element 202a), the total gain of the array system 200 in a certain spatial direction is varied as 20*log(N_{enabled}), where N_{enabled} is the number of enabled antennas in the array system 200. The gain is varied such that the power amplifiers 220 of the enabled channels (e.g., the antenna elements 202) may continue operating in a maximum-gain setting, with maximum efficiency.

For example, if the array system 200 has eight antenna elements 202, enabling or disabling individual antenna elements 202 may allow the gain controller 240 to set the overall gain of the array system 200 to G+0 dB, G+6 dB, G+9.5 dB, G+12 dB, G+14 dB, G+15.6 dB, G+16.9 dB, and G+18 dB incrementally for each of one through eight enabled elements 202, where G is an offset gain. This may be possible without affecting the bias or the output power of enabled power amplifiers 220. When N_{enabled} approaches 1, the variation in gain when enabling or disabling the antenna elements 202 becomes large, such as the drop depicted at the point 330. Accordingly, the gain controller 240 may adjust the gain of the enabled PAs 220 to an intermediate power (EIRP) level and associated efficiency.

Viewed from the right to the left, FIG. 3 depicts such a logarithmic increase in the effect of disabling a single transceiver 250. At the point 304, the system 200 is operating at the maximum efficiency and the maximum EIRP. In an embodiment, this may indicate that all of the transceivers 250a-n (and corresponding PAs 220) are all functioning at maximum gain. In the event one or more of the antenna elements 202 is blocked, one or more of the power detectors 242 may indicate to the gain controller that there is a partial obstruction of one or more of the antenna elements 202. The gain controller 240 may then command a deactivation of the one or more transceivers without affecting the system efficiency, until EIRP is reduced to a point 314, below which deactivating (e.g., turning off) additional transceivers results in larger-than-desired EIRP steps. At the point 314, if incremental reductions in EIRP in smaller increments than are possible from completely deactivating another transceiver are required, the gain controller 240 may command a decrease in the gain of one or more of the enabled PAs 220a-n. The decrease in gain may result in a decrease in EIRP and efficiency toward the point 315.

At the point 315, the efficiency decreases with the decreased EIRP to a level where the gain controller 240 may disable one of the transceivers 250a-n. The gain controller 250 may further simultaneously reset the gains of transceivers 250 that remain enabled to their individual maximum linear value. In an embodiment, when only one of the transceivers 250a-n is disabled, and n-1 transceivers 250 remain enabled, the EIRP may be reduced by an EIRP step defined by the value, 20*log(n/(n-1)) dB, which can be smaller than a maximum allowed EIRP step. The EIRP step may describe the reduction in EIRP from the point 314 to the point 315, for example. Because the step from the point 314 to the point 315 is small, there may be no need to adjust the gains of the PAs 220 of enabled transceivers 250.

The EIRP can be further reduced by deactivating transceivers 250 until the EIRP step value, 20*log(N_{enabled}/(N_{enabled}+1)), becomes larger than a maximum allowed EIRP step (e.g., at the point 314), as noted above. In other words, the magnitude of successive EIRP decrements may increase because the ratio of enabled transceivers 250 to total transceivers 250 available becomes smaller. Therefore, additional reduction in EIRP may be achieved by reducing the gain of one or more PAs 220 of the enabled transceivers 250 until EIRP moves toward the point 315, at which point the gain reduction of enabled transceivers is equal to 20*log(N_{enabled}/(N_{enabled}+1)). Adjusting EIRP below the point 315 can be accomplished by deactivating one more transceivers 250 while simultaneously restoring the gain of the PAs 220 associated with the other enabled transceivers 250 to their maximum linear values, and so on. This may result in an optimum performance of the enabled PAs 220 associated with un-obstructed antenna elements 202.

In an embodiment, each transceiver 250, and by extension, each antenna element 202 (antenna) of the phased array is configured to be enabled or disabled as determined by the gain controller 240. The Tx in 204 and the Rx out 205 connected (via the internal connections) to individual antenna elements 202 may effectively be turned ON and OFF (e.g., an ON/OFF switch) as indicated in FIG. 2. The gain controller 240 may generate signals to command the transceivers 250 connected to individual antennas elements 202.

Accordingly at lower gain modes of the array system 200 or during partial hand blockage of one or more antenna elements 202, a significant improvement in transmit and receive efficiency over the system described in connection with FIG. 1 may be realized when the gain controller 240 is configured to selectively enable/disable the transceiver blocks 250. The efficiency of the array system 200 as described in FIG. 3 can increase efficiency at the gain settings Gmax−20 log(N), where N is the number of antennas.

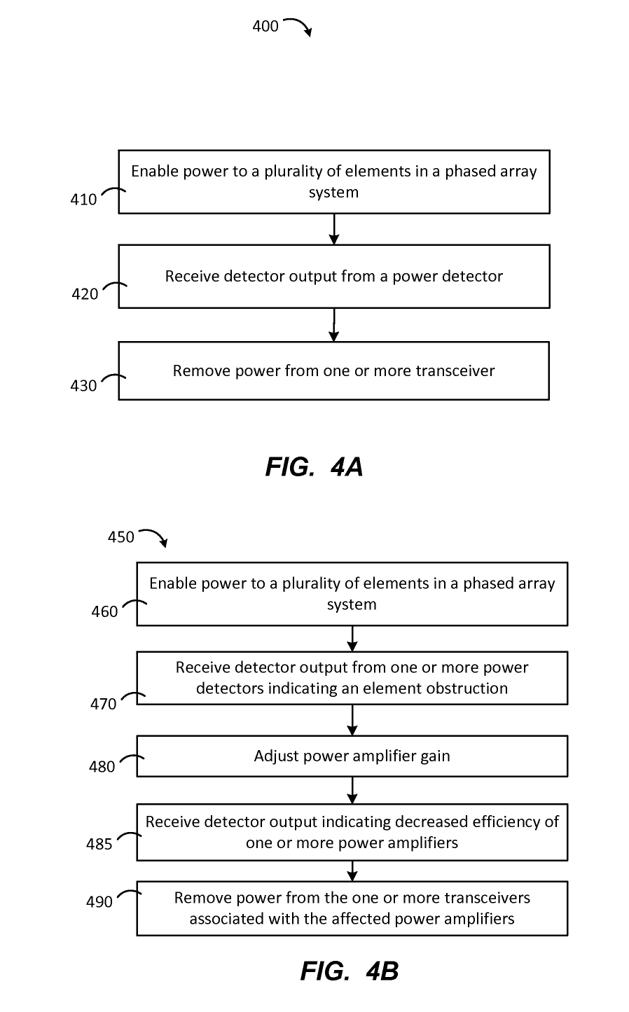

FIG. 4A is a flowchart depicting a method for selectively disabling transceivers to maintain optimum efficiency in a phased array system, according to the disclosure. As shown a method 400 begins at block 410 where the phased array system 200 enables a plurality of the antenna elements 202 in the array. In an embodiment, enabling may refer to applying power to the transceivers 250 associate with the plurality of selectively enabled antenna elements 202. In another embodiment, the selectively enabled antenna elements 202 may comprise all of the antenna elements 202 in the array 200. In yet another embodiment, the gain controller 240 may function to enable the antenna elements 202, as disclosed herein.

At block 420, the gain controller 240 may receive an input from one or more of the power detectors 242 and the RSSI 244. The input and the RSSI 244 may also be collectively referred to as a detector output. Such an output may be indicative of reflected power at the one or more antenna elements 202. Accordingly, the detector output may indicate that one or more of the antenna elements 202 may be obstructed or otherwise blocked. In an embodiment continued transmission (e.g., by the associated transceiver 250) in the presence of the obstruction may result in wasted power and lower efficiency.

At block 430 the gain controller 240 may, in response to the detector output, remove power from the transceiver 250 associated with the affected antenna element(s) 202. In an embodiment, removing power from the transceiver 250 may refer to turning the transmitter/receiver pair associated with the affected antenna element(s) 202 off As a result, the antenna elements 202 that remain active (e.g., the unblocked antenna elements 202) will continue operating at their maximum efficiency as disclosed herein.

In some embodiments, the method 400 may be employed to maintain or otherwise achieve a maximum efficiency of the array system 200 by enabling and disabling selected transceivers 250 based on the detector outputs.

FIG. 4B is a flowchart depicting another embodiment for selectively disabling transceivers to maintain optimum efficiency in a phased array system, according to the disclosure. As shown, the method 450 begins with block 460 where a plurality of antenna elements 202 of a phased array system 200 are enabled. In an embodiment, such a plurality may be all of the antenna elements 202 in the system 200.

At block 470, the gain controller 240 may receive a power detector output (e.g., from the power detector 242). The detector output may indicate operation in a state approaching the maximum linear EIRP of the system 200. In an embodiment, such an output may be result of a comparison between the output power level, the gain of the power amplifiers 220 and the RSSI 244. The detector output may further indicate a partial or total blockage of one or more antenna elements 202. At block 480, the gain controller 240 may adjust the gain of one or more of the power amplifiers 220 associated with the affected transceivers 250. In an embodiment, the “adjusting” may include an increase or decrease of the gain of the affected power amplifiers 220.

At block 485, in response to the adjusted gain(s) power amplifiers 220, the gain controller 240 may receive a detector output (e.g., from the power detector 242) indicative of a decrease in efficiency of the adjusted power amplifiers 220 or their associated transceivers 250, antenna elements 202, and/or the entire array system 200.

At block 490, the gain controller 240 may further remove power from the affected transceiver(s) 250 in response to the decreased efficiency of the power amplifiers 220. In an embodiment, removing the power from the transceivers 250 that are operating below optimum performance may increase the overall transmission efficiency of the entire system 200 and allow the remaining enabled transceivers 250 (e.g., the transceivers 250 that are not affected by the blockage) and the associated power amplifiers 220 to continue to operate at their maximum efficiency.

Accordingly, in some embodiments, the gain controller 240 may receive the detector output at block 470 or block 485 and enable or disable the transceivers 250 (and by extension, the power amplifiers 220) in order to achieve or otherwise maintain a maximum EIRP of the phased array system 200.

Although embodiments of the disclosure are described above for particular embodiments, many variations of the invention are possible. For example, the numbers of various components may be increased or decreased, modules and steps that determine a supply voltage may be modified to determine a frequency, another system parameter, or a combination of parameters. Additionally, features of the various embodiments may be combined in combinations that differ from those described above.

Those of skill will appreciate that the various illustrative blocks described in connection with the embodiments disclosed herein can be implemented in various forms. Some blocks have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the invention. In addition, the grouping of functions within a block or step is for ease of description. Specific functions or steps can be moved from one block or distributed across to blocks without departing from the present disclosure.

The various illustrative logical blocks described in connection with the embodiments disclosed herein, for example, gain controller 240, can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller (e.g., the gain controller 240 as disclosed herein), microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the present disclosure. Various modifications to these embodiments will be readily apparent to those skilled in the art, and the generic principles described herein can be applied to other embodiments without departing from the spirit or scope of the present disclosure. Thus, it is to be understood that the description and drawings presented herein represent a presently preferred embodiment of the present disclosure and are therefore representative of the subject matter which is broadly contemplated by the present disclosure. It is further understood that the scope of the present disclosure fully encompasses other embodiments that may become obvious to those skilled in the art and that the scope of the present disclosure is accordingly limited by nothing other than the appended claims.

What is claimed is:

1. A phased array system, comprising:
a first antenna element and a second antenna element;
a first transceiver having a first power amplifier, the first transceiver operably coupled to the first antenna element;
a second transceiver having a second power amplifier, the second transceiver operably coupled to the second antenna element;
a first power detector coupled to the first antenna element and configured to provide a first detector output;
a second power detector coupled to the second antenna element and configured to provide a second detector output; and
a gain controller operably coupled to the first transceiver, the first power detector, the second transceiver and the second power detector, the gain controller configured to disable one or more of the first transceiver and the second transceiver based on the first detector output and the second detector output.

2. The phased array system of claim 1, wherein the gain controller is further configured to enable or disable one or more of the first transceiver and the second transceiver when one of the first detector output and the second detector output is indicative that the phased array system is operating in a state within a predetermined range of maximum linear effective isotropically radiated power (EIRP).

3. The phased array system of claim 1, wherein the gain controller is configured to transmit commands to the first power amplifier and the second power amplifier to maintain a maximum efficiency and a maximum gain of the first power amplifier and the second power amplifier when one or more of the respective first transceiver and the second transceiver is disabled.

4. The phased array system of claim 1, wherein the gain controller is further configured to adjust a gain of one or more of the first power amplifier and the second power amplifier in response to the respective of the first detector output and the second detector output, and
wherein the gain is configured to determine an output power level of the first transceiver and the second transceiver.

5. The phased array system of claim 1, further comprising more than two antenna elements and more than two transceivers and the gain controller is further operably coupled to the more than two transceivers.

6. The phased array system of claim 1, wherein the first detector output is configured to indicate when the first antenna element is obstructed based on a measurement of reflected power.

7. The phased array system of claim 6, wherein the gain controller is further configured to enable the first transceiver that was previously disabled when the first detector output indicates that the first antenna element is no longer obstructed.

8. The phased array system of claim 1, wherein the first detector output and the second detector output are configured to indicate at least an output power measurement and a received signal strength.

9. The phased array system of claim 1, wherein the first transceiver and the second transceiver each further comprise a transmitter, a receiver, and a low noise amplifier.

10. A method for wireless communication in a phased array system, the phased array system having at least a first antenna element operably coupled to a first transceiver having a first power amplifier and a second antenna element operably coupled to a second transceiver having a second power amplifier, the method comprising:
enabling the first transceiver and the second transceiver;
detecting a detector output from at least one of the first power detector and the second power detector; and
disabling one or more of the first transceiver and the second transceiver based on the detector output while maintaining operation of the phased array system in a predetermined range of maximum efficiency.

11. The method of claim 10 further comprising enabling or disabling one or more of the first transceiver and the second transceiver when the detector output indicates that the phased array system is operating in a state within a predetermined range of maximum linear effective isotropically radiated power (EIRP).

12. The method of claim 10 further comprising adjusting a gain of one or more of the first power amplifier and the second power amplifier in response to the detector output, the gain determining an output power level of the respective first transceiver or the second transceiver.

13. The method of claim 10, wherein the disabling is further based on the detector output indicating a measurement of reflected power at one or more of the first antenna element and the second antenna element indicating an antenna element obstruction.

14. The method of claim 13 further comprising enabling one or more of the first transceiver and the second transceiver that was previously disabled, when the respective of the first detector output or the second detector output indicates the first antenna element or the second antenna element associated with disabled first transceiver or second transceiver is no longer obstructed.

15. The method of claim 10 further comprising receiving an output power measurement and a received signal strength from one or more of the first power detector and the second power detector.

16. The method of claim 10, wherein each of the first transceiver and the second transceiver further comprise a transmitter, a receiver, and a low noise amplifier.

17. An apparatus for wireless communication in a phased array system, the phased array system having a first antenna element and a second antenna element operably coupled to a respective first transceiver and a second transceiver of a plurality of transceivers, the apparatus comprising:
a gain controlling means for
enabling each of the first transceiver and the second transceiver, and
disabling one or more of the first transceiver and the second transceiver based on a detector output while maintaining maximum efficiency of the remaining enabled transceivers of the plurality of transceivers;
a first detecting means for providing a first detector output to the gain controlling means, the first detecting means operably coupled to the first antenna; and
a second detecting means for providing a second detector output to the gain controlling means, the second detecting means operably coupled to the second antenna.

18. The apparatus of claim 17, wherein the first detecting means comprises a first power detector, and wherein the second detecting means comprise a second power detector.

19. The apparatus of claim 17, wherein the gain controlling means is further configured to enable or disable one or more of the first transceiver and the second transceiver when the first detecting means or the second detecting means indicates the phased array system is operating in a state approaching maximum linear effective isotropically radiated power (EIRP).

20. The apparatus of claim 17, wherein the gain controlling means is further comprises means for adjusting a gain of one or more of the first power amplifier and the second power amplifier in response to the first detector output or the second detector output, the gain determining an output power level of the respective first transceiver or the second transceiver.

21. The apparatus of claim 17, wherein the gain controlling means is further configured to disable one or more of the first transceiver and the second transceiver based on the first detecting means or the second detecting means indicating an antenna element obstruction at one or more of the first antenna element and the second antenna element.

22. The apparatus of claim 21 wherein the gain controlling means is further configured to enable one or more of the first transceiver and the second transceiver that was previously disabled, when the respective one of the first detecting means output and the second detecting means indicates the first antenna element or the second antenna element associated with disabled first transceiver or second transceiver is no longer obstructed.

23. The apparatus of claim 17, wherein the gain controlling means further comprises means for receiving a received signal strength indication and an output power level of the first antenna and the second antenna from one or more of the first detecting means and the second detecting means.

24. The apparatus of claim 17, wherein the phased array system comprises more than two antennas and more than two transceivers.

25. A phased array system, comprising:
a plurality of antenna elements, each antenna element of the plurality of antenna elements coupled to a respective transceiver of a plurality of transceivers, each transceiver having at least one power amplifier with an adjustable gain;
a power detector coupled to each antenna element of the plurality of antenna elements and configured to provide a detector output, the detector output being configured to indicate at least an output power level and a reflected energy level at a respective antenna element of the plurality of antenna elements; and
a gain controller operably coupled to each of transceiver of the plurality of transceivers and to each power detector, the gain controller configured to:
receive the detector output, and based on the detector output:
adjust the adjustable gain of one or more selected power amplifiers to achieve a selected transmit power level for the phased array system; and
enable or disable one or more of the transceivers of the plurality of transceivers.

26. The phased array system of claim 25, wherein the gain controller is further configured to enable or disable one or more of the transceivers of the plurality of transceivers when the detector output indicates the phased array is operating in a state approaching maximum linear effective isotropically radiated power (EIRP).

27. The phased array system of claim 25, wherein a plurality of enabled power amplifiers continuously operates at maximum efficiency and maximum gain when one or more of the other transceivers of the plurality of transceivers is disabled.

28. The phased array system of claim 25, wherein the gain controller is configured to disable one or more transceivers of the plurality of transceivers when the detector output indicates a measurement of reflected power at one or more of the plurality of antenna elements indicative of an obstruction of at least one antenna element of the plurality of antenna elements.
